(19) United States
(12) Patent Application Publication
(10) Pub. No.: US 2017/0122805 A1
(43) Pub. Date: May 4, 2017

(54) LIBS SURFACE CLEANING AND ANALYSIS METHOD

(71) Applicant: SciAps, Inc., Woburn, MA (US)

(72) Inventors: David R. Day, Boxford, MA (US); John Francis Egan, Danvers, MA (US)

(21) Appl. No.: 14/932,353

(22) Filed: Nov. 4, 2015

(51) Int. Cl. G01J 3/02; G01J 3/443; B08B 7/00; G01N 21/71

(52) U.S. Cl. CPC G01J 3/027; G01N 21/718; G01J 3/443; B08B 7/0042; G01N 2201/06113; G01N 2201/069

(57) ABSTRACT

A LIBS analysis method and apparatus wherein multiple laser firings in a burst mode are produced to clean a location on the sample. Subsequently. for data collection, pumping the laser produces one or more analysis laser firings and when such a laser firing is detected, the laser pumping stops and the method includes initiating a delay period of time after which the spectrometer is triggered to begin analysis of the resulting plasma produced on the sample.

### FIELD OF THE INVENTION

The subject invention relates to spectroscopic instruments, in one example, a handheld LIBS analyzer.

### BACKGROUND OF THE INVENTION

Various spectroscopic instruments are known. X-ray based instruments, for example, can be used to determine the elemental make up of a sample using x-ray florescence spectroscopy. Portable XRF has become a preferred technique for elemental analysis in the field. Portable XRF is fast, non-destructive, and provides reasonably accurate results (i.e., quantification of elemental concentrations in a wide variety of samples). With XRF, an x-ray tube is used to direct x-rays at a sample. Atoms in the sample absorb x-rays and re-emit x-rays that are unique to the atomic structure of a given element. A detector measures the energy of each x-ray and counts the total number of x-rays produced at a given energy. From this information, the types of elements and the concentration of each element can be deduced. Commercially available analyzers include the Delta manufactured by Olympus NDT and the Niton XLT-3 manufactured by Thermo Fisher Scientific.

X-rays, however, pose a safety concern. Also, portable and benchtop XRF analyzers have not to date been used to determine lower atomic number elements such as beryllium, sodium, carbon, boron, oxygen, nitrogen, lithium, and the like.

Laser induced break down spectroscopy (LIBS) devices are known and used to detect the elemental concentration of elements with some accuracy. These devices typically include a high powered laser that sufficiently heats a portion of the sample to produce a plasma. As the plasma cools, eventually the electrons return to their ground states. In the process, photons are emitted at wavelengths unique to the specific elements comprising the sample. The photon detection and subsequent measurement of elemental concentrations are similar to spark optical emission spectroscopy (OES). Examples of LIBS devices are the LIBS SCAN 25 from Applied Photonics, the LIBS25000 from Ocean Optics, and the RT 100 from Applied Spectra. See also Nos. U.S. 2012/0044488 and WO 2013/083950 (PCT/GB2012/000892) incorporated herein by this reference.

In some prior methods, several cleaning laser firings are directed to the sample. For spectrum collection, one or more laser firings are directed to the sample integrating the resulting plasma spectral wavelengths. To allow for several spectrum collection firings, each such firing must be delayed from between 10 and 100 milliseconds to allow for spectral data processing between the firings. Thus, 10 cleaning firings followed by 10 spectrum analysis firing at each location on a sample can take a second or more.

In a “burst” mode system, see WO 2015/057784 incorporated herein by this reference, an active Q-switched laser may be continually pumped and detector integration starts and continues for typically one millisecond or more. 10 cleaning laser firings followed by 10 spectral analysis laser firings at a location may then take less than a second.

But, because an active Q-switched laser is used, the result is a more expensive, more complex LIBS analysis system. The electronic subsystem associated with an active Q-switched laser may not be amenable to hand held lasers. Further, as spectrometer data collection continues without delay when an active Q-switched laser is used, Bremsstrahlung radiation is collected by the CCD of the spectrometer resulting in excessive background noise and a poor signal.

### SUMMARY OF THE INVENTION

In one aspect, the invention relates to laser cleaning firings using the “burst” mode technique to more quickly clean a sample location followed by one or more spectral analysis firings with a programmable delay between a spectral analysis laser firing and integration of the spectrum to allow Bremsstrahlung radiation to dissipate and not be collected as part of the integration signal.

Featured is a LIBS analysis method comprising producing multiple laser firings in a burst mode to clean a location on a sample. The laser is pumped thereafter to produce one or more analysis laser firings. After detecting an analysis laser firing, stopping the laser pumping ceases and a delay period of time is initiated before signaling the spectrometer to begin analysis of the resulting plasma produced on the sample.

Preferably, the laser is a passive Q-switched laser. In one version, pumping of the laser terminates between the cleaning laser firings and the analysis laser firing. In another version, during the burst mode, N laser firings are produced N-1 laser firings are cleaning laser firings, and the N^{th} laser firing is an analysis laser firing.

Also featured is a LIBS analyzer comprising a passive Q-switched laser for creating a plasma on a sample, a detector configured to detect laser firings, and a spectrometer configured to receive plasma radiation from the sample and to integrate the plasma spectrum. A controller subsystem is responsive to the detector and to the spectrometer and is configured to control the laser to produce multiple laser firings in a burst mode to clean a location on the sample. Then, pumping the laser produces one or more analysis laser firing. After the detector detects an analysis laser firing, pumping the laser stops and a delay is initiated before signaling the spectrometer to integrate the plasma spectrum.

In one example, the controller subsystem is configured to terminate pumping of the laser between the cleaning laser firings and the analysis laser firing(s). In another example, during the burst mode, the controller subsystem is configured to produce N laser firings wherein N-1 laser firings are cleaning laser firings and the N^{th} laser firing is an analysis laser firing.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is an illustration showing several cleaning laser firings followed by a spectral analysis laser firing in accordance with a prior art method;

FIG. 2 is an illustration showing laser firings in a prior art “burst mode”;

FIG. 3 is an illustration showing, in one example of the invention, several cleaning laser firings in a “burst mode” followed by an analysis laser firing with a delay imposed before signal integration of the spectrum detected;

FIG. 4 is an illustration showing several “burst mode” cleaning laser firings the last of which is used as a spectral analysis laser firing in accordance with another example;

FIG. 5 is a block diagram showing several of the primary components associated with a LIBS analyzer in accordance with an example of the invention;

FIG. 6 is a flow chart depicting the primary steps associated with one preferred method and also explaining the primary programming configuration of the controller subsystem shown in FIG. 5; and

FIG. 7 is flow chart depicting the primary steps associated with another analysis method and also associated with the primary programming configuration of the controller subsystem of FIG. 5.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

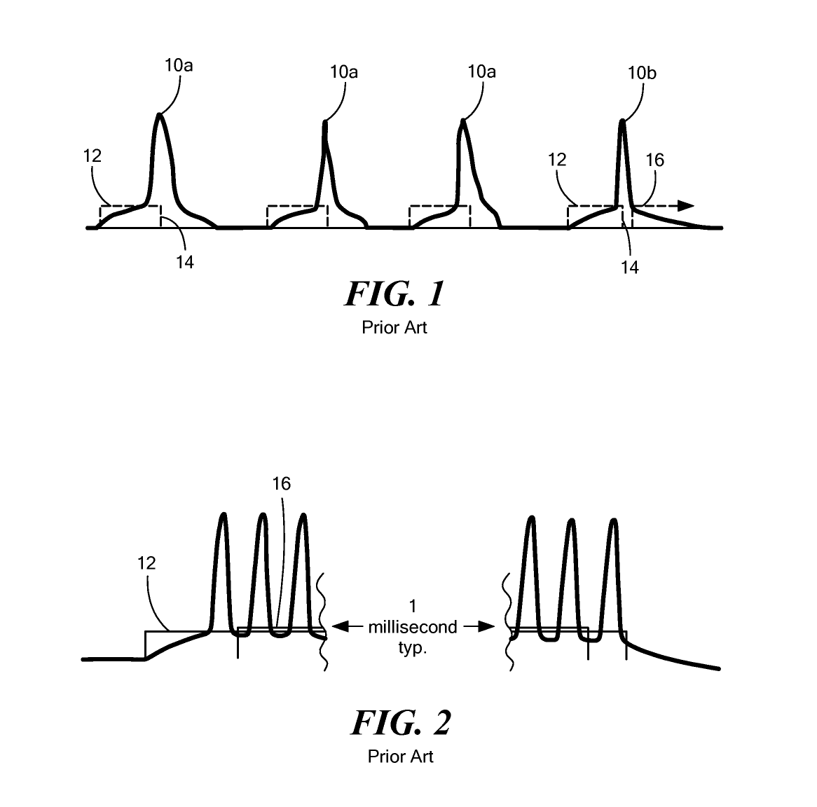

In FIG. 1, several cleaning laser firings 10a are directed to the sample as the passive Q switch laser is pumped as shown at 12, the laser flashes are detected (e.g., using a photodiode), and power to the pumping laser is stopped as shown at 14. For spectrum collection, a laser firing at 10b is directed to the sample and a delay may be imposed as shown at 16 before the spectrometer (including, for example, a CCD) begins integrating the resulting plasma spectral wavelengths. To allow for several spectrum collection firings, each such firing 10b must be delayed from between 10 and 100 milliseconds to allow for spectral data processing between the firings. Thus, 10 cleaning firings followed by 10 spectrum analysis firings at each location on a sample can take a second or more. In a “burst mode” system, see WO 2015/057784 incorporated herein by this reference, an active Q-switched laser may be continually pumped as shown at 12, FIG. 2 and detector integration starts and continues for typically one millisecond or more. 10 cleaning laser firings followed by 10 spectral analysis laser firings at a location (the spectrums collected from the cleaning firings may be discarded) will then only take less than a second.

But, because an active Q-switched laser is used, the result is a more expensive, more complex LIBS analysis system. The electronic subsystem associated with an active Q-switched laser may not be amenable to hand held lasers. Further, as spectrometer data collection continues without delay when an active Q-switched laser is used, Bremsstrahlung radiation is collected by the CCD resulting in excessive background noise and a poor signal.

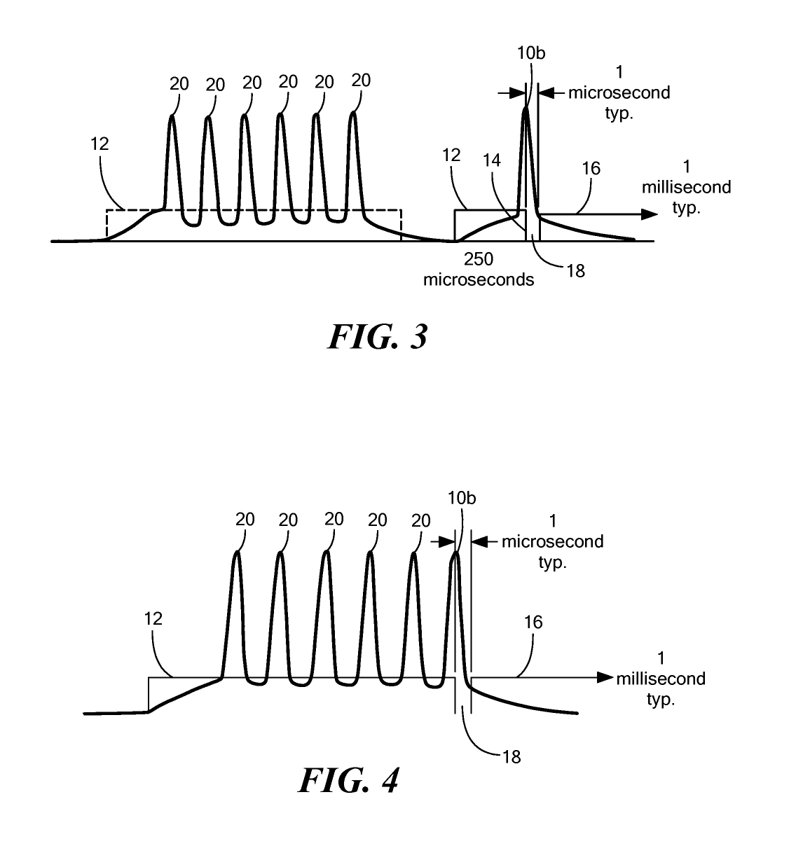

In one example of the invention as shown in FIG. 3, laser cleaning firings are performed at a location on the sample (e.g., 10-20 firings) using the “burst mode” technique as shown for laser firings 20 to more quickly clean the sample location. During the operation of the pump laser of the passive Q-switched laser as shown at 12, the laser begins to fire at 50-500 microsecond intervals for a very fast and through cleaning.

Then, after cleaning, one or more spectral analysis firings 10b are performed where the pumping power 12 is stopped after the laser firing is detected as shown at 14. Also, there is a programmable delay, typically 250 nanoseconds up to 50 microseconds, depending on the application, as shown at 18 between the detection of the laser firing at 10b and when the CCD of the spectrometer is triggered to begin signal integration of the spectrum detected. The programmable delay allows the Bremsstrahlung or continuum radiation to dissipate and not be collected as part of the integrated signal.

Integration by the spectrometer CCD starts after the delay and continues for a time period (typically less than one millisecond). Additional spectral analysis firings at a given location occur in the same manner with typically a separation of spectral analysis firings of at least one millisecond but typically 10-100 milliseconds to allow for data processing between firings.

The laser focal spot may then be automatically moved to a new location on the sample for additional cleaning and spectral analysis firings. Focusing of the laser spot may also be automated. See U.S. patent application Ser. No. 14/874,726 filed Oct. 5, 2015 incorporated herein by this reference.

The result is a passive Q-switched laser system providing faster cleaning and yet at the same time a better analysis signal. Battery power is conserved and heat build-up is reduced which may be especially important in a portable LIBS analyzer.

In FIG. 4, N (e.g., 6) laser firings are produced while the pump laser is energized as shown at 12, N-1 laser firings are used for cleaning and the Nth laser firing is used for spectral analysis. After the Nth firing is detected, the pumping power is stopped, the delay is imposed as shown at 18 and the CCD of the spectrometer is then signaled to begin integration. This embodiment further shortens the time to clean and analyze the given location on a sample.

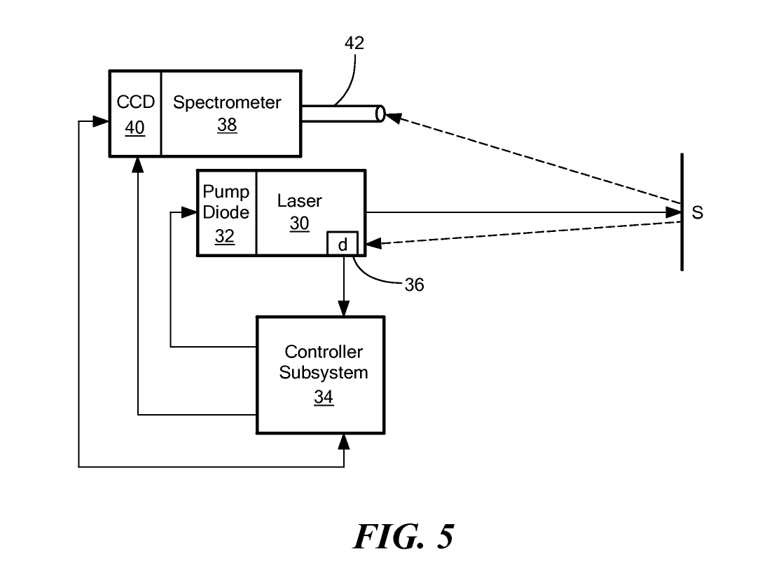

Laser 30, FIG. 5 is pumped by one or more pumping laser diodes 32 controlled by controller subsystem 34 to produce laser firings directed by an optical subsystem to sample S. Laser 30 may be a passive Q-switched laser, 5-7 MJ, with a pule width of 2 ns producing an output at 1064 nm. A detector 36, for example, a photodiode associated with laser 30, detects each laser firing and provides a corresponding signal to controller subsystem 34. Plasma radiation is directed to one or more spectrometers 38 and the CCD 40 thereof via an optical path typically including one or more optical fibers 42. See U.S. patent application Ser. No. 14/179,670 incorporated herein by this reference: Controller subsystem 34 signals CCD to begin signal integration of the spectrum detected.

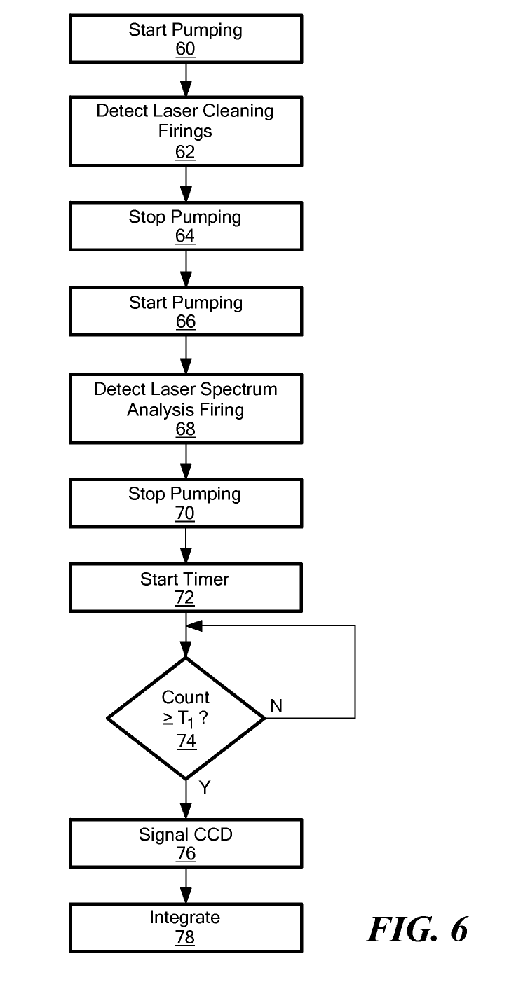

In one version as shown in FIG. 3, controller subsystem 34, FIG. 5 controls pumping diode(s) 32 to operate in a burst mode, step 50, FIG. 6. The laser 30, FIG. 5 typically fires at 50-500 microsecond intervals for a very fast and through cleaning of sample S. The laser firings are detected by detector 36 and counted by controller subsystem 34, step 62, FIG. 6. When a predetermined number of cleaning laser firings have occurred, controller subsystem 34, FIG. 5 de-energizes pump diode(s) 32 and pumping stops, step 64, FIG. 6.

Then, controller subsystem 34, FIG. 5 signals pump diode(s) 32 to initiate pumping again, step 66, FIG. 6. When detector 36, FIG. 5 detects the spectral analysis firing 10-b, FIG. 3 as shown at step 68, FIG. 6, controller subsystem 34, FIG. 5 de-energizes the pumping diode(s) and pumping stops, step 70, FIG. 6. At the same time, a timer is started, step 72 to delay CCD signal integration until the count reaches a program delay (e.g., 250 nanoseconds to 50 microseconds), step 74, FIG. 6 after which controller subsystem 34, FIG. 5 signals CCD 40, FIG. 5, step 76, FIG. 6 to being signal integration, step 78 of the spectrum detected and delivered to the spectrometer 38, FIG. 5 via fiber optic 42. As noted previously, this delay allows for Bremsstrahlung radiation to dissipate.

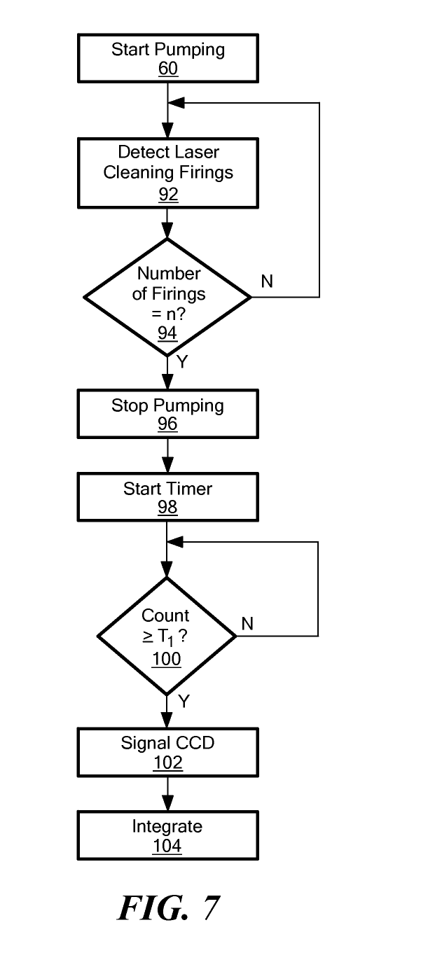

Alternatively, controller subsystem 34, FIG. 5 may be programmed to produce the pulse train shown in FIG. 4. As depicted in FIG. 7, controller subsystem 34, FIG. 5 signals pump diode(s) 32 to begin pumping in a burst mode, step 90 FIG. 7. Laser cleaning firings 20, FIG. 4 are detected by detector 36, FIG. 5, step 92, FIG. 7 and controller subsystem 34, FIG. 5 tracks the number of firings until a preset number of firings occur, step 94, FIG. 7 after which controller subsystem 34 de-energizes pump diode(s) 32, FIG. 5, step 96, FIG. 7.

As shown, a delay is imposed, steps 98-100 (see delay 18, FIG. 4) before controller subsystem 34, FIG. 5 signals the CCD 40 to begin signal integration, steps 102 and 104, FIG. 7 of the spectrum delivered to spectrometer 38, FIG. 5 via fiber optic 42.

The controller subsystem may include one or more microcontrollers, microprocessors, application specific integrated circuits, field programmable gate arrays or similar electronic devices. The various power supplies of the system are not shown in FIG. 5 for clarity. The CCD output s typically provided to a processor of the controller subsystem 34 which performs signal analysis functions to output, typically to a user display, the elements present in the sample and their concentrations based on a spectral analysis of the plasma.

The result is a LIBS analysis system, typically configured as a handheld unit, where Bremsstrahlung or continuum radiation dissipates and is not collected as part of the integrated signal and yet cleaning at a given location on a sample occurs very quickly. Faster cleaning and yet, at the same time, a better analysis signal is provided, battery power is conserved, and heat build-up is reduced.

Although specific features of the invention are shown in some drawings and not in others, this is for convenience only as each feature may be combined with any or all of the other features in accordance with the invention. The words “including”, “comprising”, “'having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A LIBS analysis method comprising:
producing multiple laser firings in a burst mode to clean a location on a sample;
pumping the laser to produce one or more analysis laser firings;
detecting an analysis laser firing;
stopping the laser pumping;
initiating a delay period of time; and
at the end of the delay period of time, signaling a spectrometer to begin analysis of the resulting plasma produced on the sample.

2. The method of claim 1 in which the laser is a passive Q-switched laser.

3. The method of claim 1 in which pumping the laser terminates between the cleaning laser firings and the analysis laser firing.

4. The method of claim 1 in which, during the burst mode, N laser firings are produced, N-1 laser firings are cleaning laser firings, and the N^{th} laser firing is an analysis laser firing.

5. A LIMB analyzer comprising:
a passive Q-switched laser for creating a plasma on a sample;
a detector configured to detect laser firings;
a spectrometer configured to receive plasma radiation from the sample and to integrate the plasma spectrum; and
a controller subsystem responsive to the detector and the spectrometer and configured to:
control the laser to produce multiple laser firings in a burst mode to clean a location on the sample,
pump the laser to produce one or more analysis laser firings,
stop pumping the laser and initiating a delay after the detector signals the controller subsystem, and
signal the spectrometer, after the delay, to integrate the plasma spectrum.

6. The analyzer of claim 5 in which the controller subsystem is configured to terminate pumping of the laser between the cleaning laser firings and the analysis laser firing.

7. The analyzer of claim 5 in which, during the burst mode, the controller subsystem s configured to produce N laser firings wherein N-1 laser firings are cleaning laser firings and the N^{th} laser firing is an analysis laser firing.
